(19) United States
(12) Patent Application Publication
(10) Pub. No.: US 2020/0148049 A1
(43) Pub. Date: May 14, 2020

(54) PROTECTIVE COVER FOR MOTORCYCLE HYDRAULIC ASSEMBLY

(71) Applicant: Robert L. Barnett, Santa Ana, CA (US)

(72) Inventor: Robert L. Barnett, Santa Ana, CA (US)

(21) Appl. No.: 16/682,944

(22) Filed: Nov. 13, 2019

Related U.S. Application Data
(60) Provisional application No. 62/760,752, filed on Nov. 13, 2018.

(51) Int. Cl. B60J 11/06

(52) U.S. Cl. CPC B60J 11/06

(57) ABSTRACT

A protective cover for a hydraulic clutch or brake assembly is provided. The protective cover can have a pressure tube portion sized to fit over at least a portion of a master cylinder of the hydraulic brake or clutch assembly. The protective cover can further include a reservoir portion sized to fit over at least a portion of a reservoir of the hydraulic brake or clutch assembly. The reservoir portion can extend away from the pressure tube portion along a second longitudinal direction. The protective cover can further include a pivot portion that extends away from the pressure tube portion along the first longitudinal direction. The pressure tube portion can include a plurality of ribs that reduce or eliminate the master cylinder of the hydraulic clutch or brake assembly becoming damaged or deformed due to rocks or debris impacting a front face of the protective cover.

### INCORPORATION BY REFERENCE TO ANY PRIORITY APPLICATIONS

Any and all applications for which a foreign or domestic priority claim is identified in the Application Data Sheet as filed with the present application are hereby incorporated by reference herein and made a part of the present disclosure.

### BACKGROUND

### Field

The present disclosure relates generally to a protective cover for a hydraulic brake or clutch system and, in particular, for a handbrake or hand clutch system for a motorcycle, dirt bike, or ATV.

### Description of Related Art

Hydraulic brake systems often use an incompressible fluid to generate leverage for squeezing a brake pad against a rotor. In a hydraulic handbrake system, when the brake lever is squeezed, a pushrod exerts force on a piston in the master cylinder. Movement of the piston in the master cylinder seals off the bypass or compensation port, trapping fluid ahead of the piston. Further movement of the piston increases the pressure of the entire hydraulic system, forcing fluid through the hydraulic lines toward one or more calipers where the fluid acts upon one or two caliper pistons sealed by one or more seated O-rings that prevent leakage of the fluid.

Subsequent release of the brake lever allows a return mechanism (e.g., a spring in the master cylinder assembly) to return the master piston back into its rest position. This return action first relieves the hydraulic pressure on the caliper, then applies suction to the brake piston in the caliper assembly, moving it back into its housing and allowing the brake pads to release the rotor. Similar principles can be used to engage and disengage a hydraulic clutch system.

### SUMMARY

The systems, methods and devices described herein have innovative aspects, no single one of which is indispensable or solely responsible for their desirable attributes. Without limiting the scope of the claims, some of the advantageous features will now be summarized.

An aspect of the present invention is a protective cover for a hydraulic brake or clutch assembly. The protective cover can include a pressure tube portion, a reservoir portion, and a pivot portion. The pressure tube portion can be sized to fit over at least a portion of a master cylinder of the hydraulic brake or clutch assembly. The pressure tube portion can extend along a first longitudinal direction. The reservoir portion can be sized to fit over at least a portion of a reservoir of the hydraulic brake or clutch assembly. The reservoir portion can extend away from the pressure tube portion along a second longitudinal direction. The pivot portion can extend away from the pressure tube portion along the first longitudinal direction.

In some variants, the protective cover can include a plurality of ribs disposed on the pressure tube portion. In some aspects, at least one of the plurality of ribs can be disposed on an inner surface of the pressure tube portion. In some aspects, at least one of the plurality of ribs can be disposed on an outer surface of the pressure tube portion. In some aspects, at least one of the plurality of ribs can extend along the first longitudinal direction. In some aspects, at least one of the plurality of ribs can extend along a circumferential direction of the pressure tube portion. In some arrangements, the first and second longitudinal directions can be orthogonal to one another. In some arrangements, at least two of the pressure tube portion, the reservoir portion, and the pivot portion form a unitary structure with one another. In some variants, the pressure tube portion, the reservoir portion, and the pivot portion form a unitary structure. In some aspects, the pivot portion can be disposed adjacent to a left side portion of the pressure tube portion as viewed from a front of the protective cover. In some aspects, the pivot portion can be disposed adjacent to a right side portion of the pressure tube portion as viewed from a front of the protective cover. In some arrangements, the protective cover can include a flange that extends along the pressure tube portion in the first longitudinal direction and extends away from the pressure tube portion along a third longitudinal direction that is orthogonal to each of the first and second longitudinal directions. In some aspects, the flange can include a through hole. In some variants, the pivot portion can include a bottom pivot mount surface that extends away from the flange along a direction that is angled away from the reservoir portion by an angle that is between 10 degrees and 60 degrees. In some aspects, at least a portion of the flange can extend rearward beyond the reservoir portion. In some aspects, the protective cover can be made of plastic or rubber. In some aspects, the protective cover can be sufficiently resilient to allow the protective cover to be snap fitted onto the hydraulic clutch or brake assembly. In some aspects, a cross-sectional shape of the pressure tube portion, as viewed in a plane transverse to the first direction, can have a crescent shape.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Throughout the drawings, reference numbers can be reused to indicate general correspondence between reference elements.

FIG. 1 is a top view of an embodiment of a hydraulic handbrake assembly.

FIG. 2 is schematic representation of a rear cross-sectional view of a hydraulic handbrake assembly.

FIG. 3 shows a hydraulic handbrake assembly mounted on a handlebar of a dirt bike.

FIG. 4 shows an embodiment of a protective cover for a hydraulic handbrake assembly.

FIG. 5 shows a front view of the protective cover of FIG. 4.

FIG. 6 shows a rear view of the protective cover of FIG. 4.

FIG. 7 shows a left side view of the protective cover of FIG. 4.

FIG. 8 shows a right side view of the protective cover of FIG. 4.

FIG. 9 shows a top view of the protective cover of FIG. 4.

FIG. 10 shows a bottom view of the protective cover of FIG. 4.

FIG. 11 shows a front view of a protective cover according to some aspects of the present disclosure.

FIG. 12 shows a rear view of the protective cover of FIG. 11.

FIG. 13 shows a left side view of the protective cover of FIG. 11.

FIG. 14 shows a right side view of the protective cover of FIG. 11.

FIG. 15 shows a top view of the protective cover of FIG. 11.

FIG. 16 shows a bottom view of the protective cover of FIG. 11.

FIG. 17 shows a front view of a protective cover according to some aspects of the present disclosure.

FIG. 18 shows a rear view of the protective cover of FIG. 17.

FIG. 19 shows a left side view of the protective cover of FIG. 17.

FIG. 20 shows a right side view of the protective cover of FIG. 17.

FIG. 21 shows a top view of the protective cover of FIG. 17.

FIG. 22 shows a bottom view of the protective cover of FIG. 17.

FIG. 23 shows a schematic illustration of a method of securing the protective cover to the brake assembly.

FIG. 24A shows a brake assembly mounted on a handlebar of a dirt bike.

FIG. 24B shows a protective cover mounted on the brake assembly of FIG. 24A.

### DETAILED DESCRIPTION

Embodiments of systems, components and methods of assembly and manufacture will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

The protective cover of the present disclosure will now be described in the context of a cover for a handbrake assembly. However, in some embodiments, the protective cover of the present disclosure can be adapted to protect the components of a hydraulic hand clutch assembly (not shown). Although described in the context of a motorcycle, the protective cover can be used for other handlebar-equipped vehicles, such as ATV's, snowmobiles, personal watercraft, bicycles, etc.

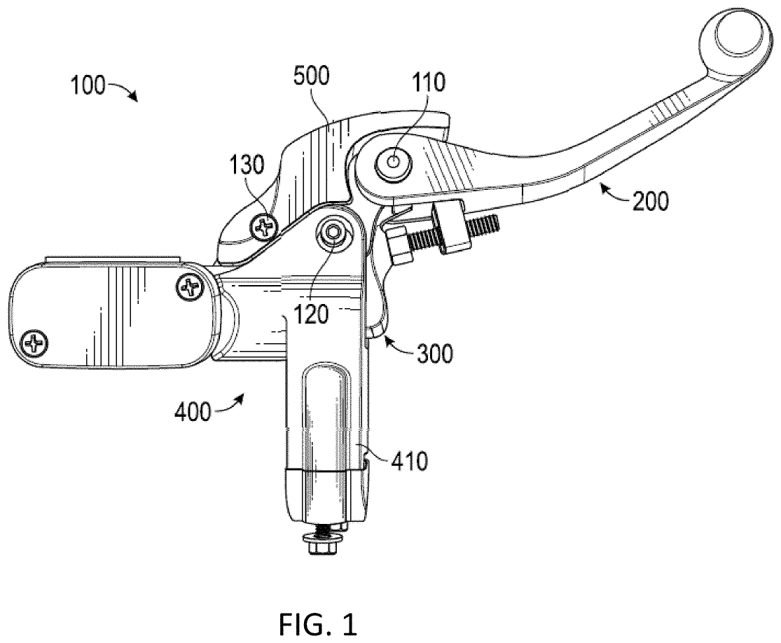

FIG. 1 depicts a top view of a non-limiting, illustrative embodiment of a brake assembly 100. The brake assembly 100 can include a lever 200, a knee 300, a master cylinder assembly 400, and a guard 500. The lever 200 can be coupled to the knee 300 by a pin 110. In some variants, the brake assembly may not include a pin 110, with the lever 200 and the knee 300 being portions of a continuous, unitary structure (which can be referred to as a “lever”). The pin 110 can be many different types of a fastener (e.g., a bolt, a weld). The lever 200 can be adapted to rotate about the pin 110. In some embodiments, the lever 200 can be restricted from rotating about the pin 110.

The knee 300 can be coupled to the master cylinder assembly 400 by a pivot 120. The pivot 120 can be many different types of a fastener (e.g., a bolt, a screw, a pin). The knee 300 can be adapted to rotate about the pivot 120.

The guard 500 can be secured to the master cylinder assembly 400 by a fastener 130. The fastener 130 can be many different types of a fastener (e.g., a bolt, a weld). In some variants, the guard 500 can be formed as a continuous, unitary structure of another component of the brake assembly 100 (e.g., the master cylinder assembly 400, the knee 300, the lever 200).

The master cylinder assembly 400 may include or be coupled to a perch 410 that is adapted to secure the brake assembly 100 to a secondary structure (e.g., handlebar). The brake assembly 100 can be configured so that a brake is applied when the lever 200 is moved in a first direction (e.g., toward the handlebar). The brake assembly 100 can be configured so that the brake is released when the lever 200 is moved in a second direction (e.g., away from the handlebar). The brake assembly 100 can be arranged so that the brake is applied when the lever 200 rotates in a first direction about the pivot 120, and the brake is released when the lever 200 rotates in a second direction about the pivot 120, with the first and second directions being opposite directions of rotation around the pivot 120. The brake assembly 100 can be arranged so that the lever 200 pushes the knee 300 toward the master cylinder assembly 400 when the lever 200 moves toward the perch 410.

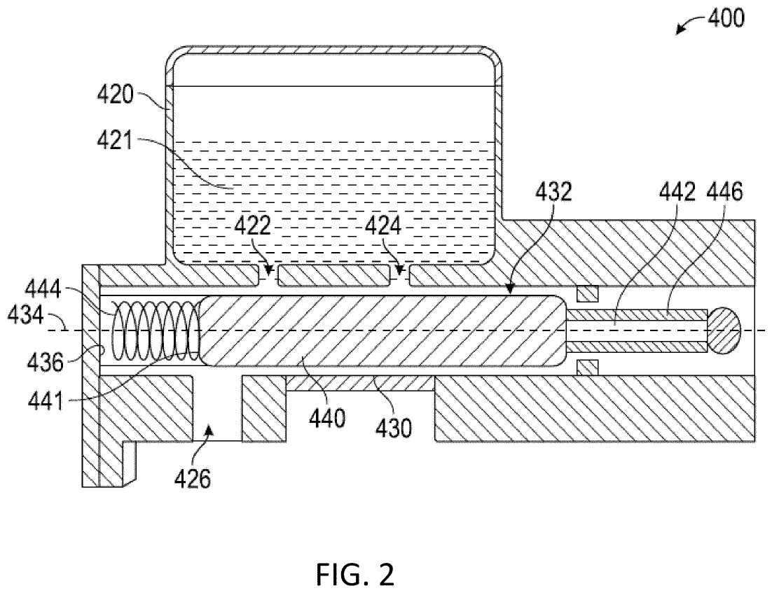

FIG. 2 depicts a rear cross-sectional view of a non-limiting, illustrative embodiment of the master cylinder assembly 400. The master cylinder assembly 400 can include a reservoir 420, a pressure tube 430, and a piston 440. The reservoir 420 can be adapted to contain a liquid 421 (e.g., brake fluid). The pressure tube 430 can surround a channel 432 that has a longitudinal axis 434. The channel 432 can be substantially cylindrical and surround the piston 440. The channel 432 can be adapted to have a small clearance between the pressure tube 430 and the piston 440. The master cylinder assembly 400 can include an inlet port 422 through which the reservoir 420 can communicate with the channel 432. The master cylinder assembly 400 can include a compensating port 424 through which the reservoir 420 can communicate with the channel 432. The master cylinder assembly 400 can include an outlet port 426 through which the channel 432 can communicate with a hydraulic brake line (not shown).

The master cylinder assembly 400 can be arranged so that the piston 440 moves within the channel 432 along the longitudinal axis 434. The piston 440 can include, or be coupled with, a pushrod 442. The piston 440 can be coupled to the pushrod 442 by a flexible joint (not shown) that allows the pushrod 442 to articulate in one or more directions relative to the piston 440. The master cylinder assembly 400 can include a sealing element 446 that surrounds the pushrod 442. The sealing element 446 can be adapted to block the liquid 421 from flowing past the pushrod 442, as shown in FIG. 2.

The master cylinder assembly 400 can include a return spring 444. The return spring 444 can be arranged to be co-axial with the channel 432. The return spring 444 can be disposed between the piston 440 and the cylinder 430. As shown in FIG. 2, the return spring 444 can be disposed between a distal end surface 436 of the channel 432 and an end 441 of the piston 440. The return spring 444 can be configured to compress when a compression force is applied to the pushrod 442, thereby allowing the piston 440 to move toward the distal end surface 436 of the channel 432. The return spring 444 can be configured to supply a restoring force such that the piston 440 moves away from the distal end surface 436 of the channel 432 when the compression force applied to the pushrod 442 is reduced.

With continued reference to FIG. 2, the master cylinder assembly 400 can be configured such that movement of the piston 440 toward the distal end surface 436 of the channel 432 increases the pressure of the liquid 421 in the outlet port 426 and in the downstream hydraulic brake line (not shown). The master cylinder assembly 400 can be configured such that movement of the piston 440 away from the distal end surface 436 of the channel 432 decreases the pressure of the liquid 421 in the outlet port 426 and in the downstream hydraulic brake line (not shown). The brake assembly can be configured so that an increase in the pressure of the liquid 421 in the outlet port 426 activates the brake. The brake assembly can be configured so that a decrease in the pressure of the liquid 421 in the outlet port 426 releases the brake. As shown in FIG. 2, the piston 440 has moved toward the distal end surface 436, thereby increasing the pressure of the liquid 421 in the outlet port 426 and activating the brake. A hydraulic hand clutch assembly (not shown) can be similarly arranged, having a piston that moves within a pressure tube to pressurize a fluid within the hydraulic clutch line. In some embodiments, the protective cover of the present disclosure can be adapted to protect the components of a hydraulic hand clutch assembly.

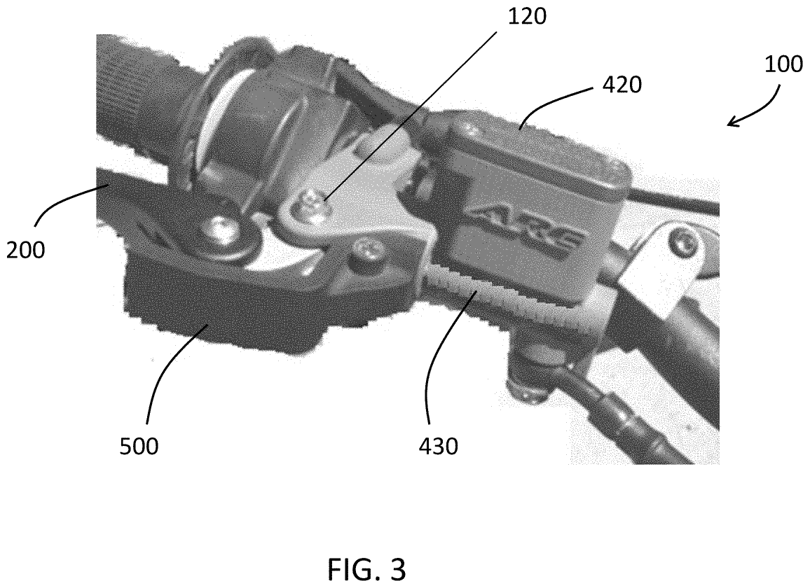

FIG. 3 depicts a front view of a brake assembly 100 mounted on a handlebar of a dirt bike. In use, the brake assembly 100 is susceptible to damage from a collision with the ground or another object (e.g., flying debris). As discussed herein, the clearance between the pressure tube 430 and the piston 440 is small. Therefore, deformation of the pressure tube 430 due to impact damage can reduce or eliminate the clearance between the pressure tube 430 and the piston 440, rendering the brake assembly 100 inoperable. In some embodiments, the protective cover of the present disclosure is adapted to protect the pressure tube 430 from impact damage that could render the brake assembly 100 inopearable.

FIG. 4 illustrates an embodiment of a protective cover 600. As discussed herein, the protective cover 600 can be adapted to protect the brake assembly 100 from impact damage. The protective cover 600 can be made of a resilient material to thereby cushion or dissipate impact forces that strike the outer surface of the protective cover 600. In this way the protective cover 600 can shield the brake assembly 100 from damage. In some aspects, the protective cover 600 can be sufficiently resilient to allow the protective cover 600 to be snap fitted onto a clutch or brake assembly. In some variants, the protective cover 600 can be deformed without the use of tools to fit the protective cover 600 onto the clutch or brake assembly 100. As discussed herein, the protective cover can include features that protect the components of the brake assembly 100 (e.g., any combination of the pressure tube 430, the reservoir 420, and the pivot 120). The protective cover 600 can fit over at least a portion of the brake assembly 100. In the illustrated embodiment, the protective cover 600 is a unitary structure. In some embodiments, the protective cover 600 can be a plurality of components that are assembled together. The protective cover 600 can be made of a flexible material (e.g., plastic, rubber). The protective cover 600 can be adapted to snap fit over or otherwise mounted on a front portion of the brake assembly 100, thereby protecting the front face of the brake assembly 100 from impact damage.

As shown in FIG. 4, the protective cover 600 can include a pivot portion 610, a reservoir portion 620, and a pressure tube portion 630. The pressure tube portion 630 can extend from the pivot portion 610 along a first direction. The pressure tube portion 630 viewed in the axial plane (e.g., a plane transverse to the first direction) can have a crescent shape or the shape of a partial cylindrical shell. The reservoir portion 620 can extend from the pressure tube portion 630 along a second direction. In the illustrated embodiment, the first and second directions are substantially orthogonal to one another. In some embodiments, the first and second directions are not substantially orthogonal to one another. In the illustrated embodiment, the reservoir portion 620 extends from the pivot portion 610 and from the pressure tube portion 630. In some embodiments, the reservoir portion 620 extends from one of the pivot portion 610 and the pressure tube portion 630 and not from the other. For example, in some embodiments, the reservoir portion 620 extends from the pressure tube portion 630 and is not in direct contact with the pivot portion 610.

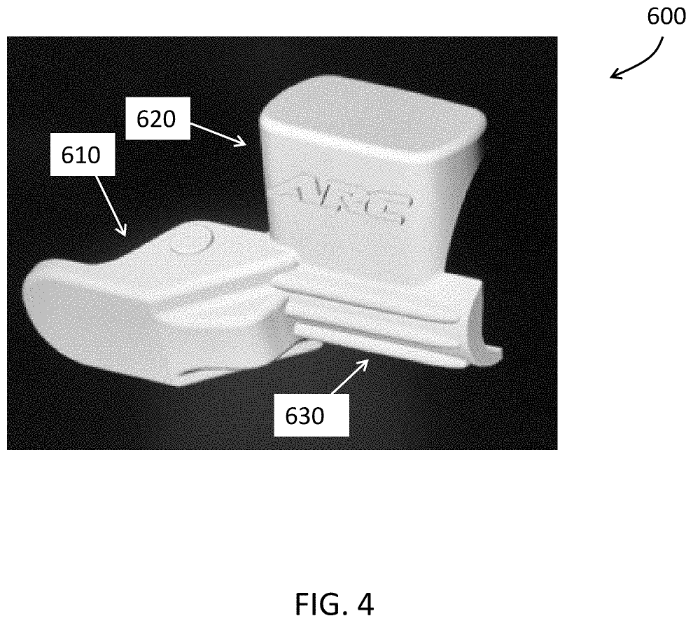

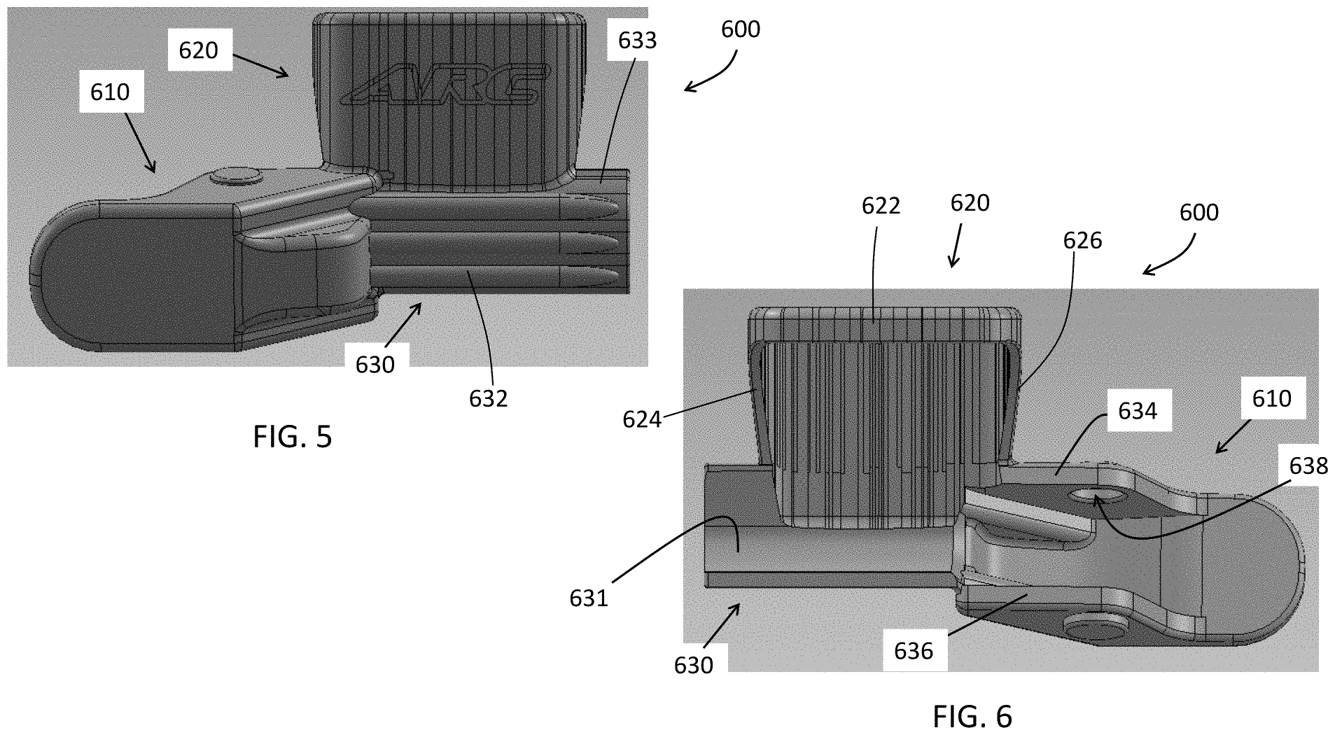

FIG. 5 is a front view of the protective cover 600. For the sake of clarity, the protective cover 600 will be described in the context of being mounted on the brake assembly 100. Accordingly, the surface of the protective cover 600 that faces away from the brake assembly 100 when the protective cover 600 is mounted on the brake assembly 100 will be referred to as an outer surface (or variations thereof). A surface of the protective cover 600 that faces toward the brake assembly 100 when the protective cover 600 is mounted on the brake assembly 100 will be referred to as an inner surface (or variations thereof). A cover intended for use with a hydraulic clutch may be a substantial mirror image of the illustrated cover 600.

As shown in FIG. 5, the pressure tube portion 630 can have one or more ribs 632 that extend from the outer surface 633 of the pressure tube portion 630. The ribs 632 can provide extra cushioning relative to an arrangement omitting the ribs 632 to minimize or prevent rock damage to the pressure tube 430 (FIG. 3) of the brake assembly 100 without the additional weight or material usage of increasing the thickness of a greater portion of or the entire pressure tube portion 630. The ribs 632 can require a bigger rock or harder hit to cause deformation damage to the pressure tube 430. The illustrated embodiment has three parallel, linear ribs 632 that extend along a longitudinal axis of the pressure tube 430. However, the ribs 632 can have any suitable shape. Other suitable arrangements or localized increases in thickness (e.g., cylindrical or hemispherical protrusions) can also be used.

FIG. 6 is a rear view of the protective cover 600. The protective cover 600 can be sufficiently pliable to allow portions of the protective cover 600 to splay apart from one another as the protective cover 600 is snap fit over (and/or otherwise mount to) the brake assembly 100. The protective cover 600 can be made of a material that has sufficiently strong elastic recoil forces such that the protective cover 600 holds the brake assembly 100 within the inner confines of the protective cover 600 after the brake assembly 100 has been inserted into protective cover 600. For example, the protective cover 600 can be mounted onto the brake assembly 100 by forcing the protective cover 600 over the brake assembly 100 such that one or more surfaces of the protective cover 600 splay apart from each other. Once the brake assembly 100 is seated in the protective cover 600, the splayed apart surfaces of the protective cover 600 can recoil to hold the brake assembly 100 within the inner confines of the protective cover 600. The protective cover 600 can be removed from the brake assembly 100 by forcing the protective cover 600 away from the brake assembly 100 such that the one or more surfaces of the protective cover 600 are splayed apart as the brake assembly 100 exits the inner confines of the protective cover 600.

With continued reference to FIG. 6, the pivot portion 610 can include a top pivot mount surface 634 and a bottom pivot mount surface 636. The top and bottom pivot mount surfaces 634, 636 can splay apart from one another as the brake assembly 100 is positioned between the top and bottom pivot mount surfaces 634, 636. Once the brake assembly 100 is seated within the inner confines of the protective cover 600, the elastic recoil forces of the top and bottom pivot mount surfaces 634, 636 can secure the protective cover 600 onto the brake assembly 100. As shown in FIG. 6, one or both of the top and bottom pivot mount surfaces 634, 636 can include a recess 638 that receives a portion of the brake assembly 100 (e.g., pivot 120). The recess 638 can enhance the ability of the protective cover 600 to retain the brake assembly 100 within the inner confines of the protective cover 600.

As shown in FIG. 6, the pressure tube portion 630 can have an inner surface 631 that is sized to partially circumferentially surround a portion of the pressure tube 430. The pressure tube 430 can splay apart the inner surface 631 as the brake assembly 100 is seated into the inner confines of the pressure tube portion 630. The elastic recoil of the splayed apart inner surface 631 can be adapted to hold the brake assembly 100 within the inner confines of the pressure tube portion 630 after the brake assembly 100 has been inserted into the protective cover 600. The reservoir portion 620 can include a top portion 622 that splays away from the other portions of the protective cover 600 to receive and retain the reservoir 420 of the brake assembly 100. In the illustrated embodiment, the reservoir portion 620 includes a first lateral surface 624 and a second lateral surface 626 that can splay apart from one another to receive the reservoir 420 of the brake assembly 100.

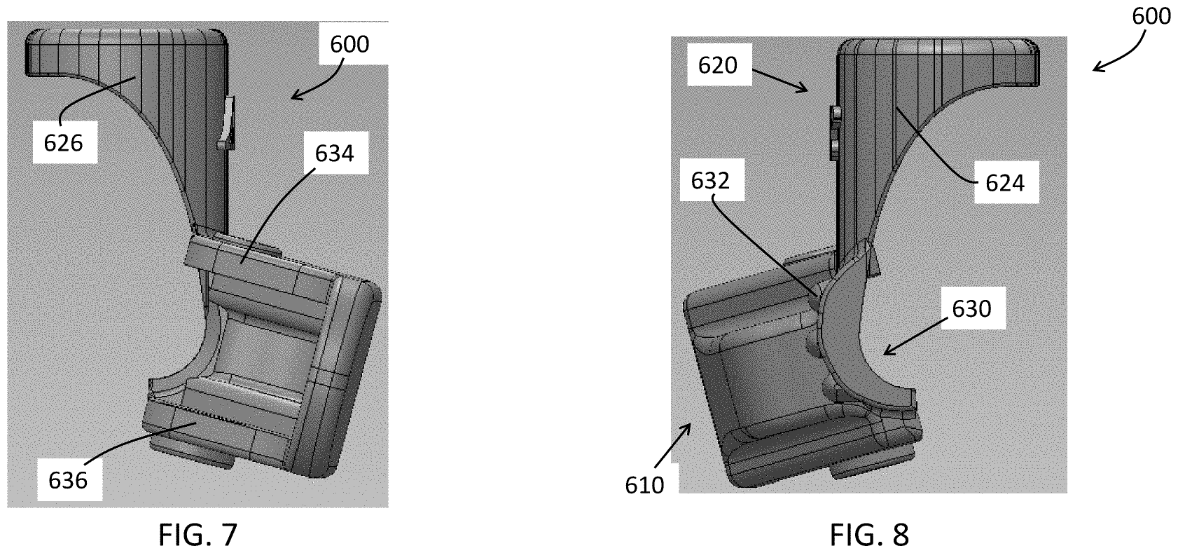

FIG. 7 is a left side view of the protective cover 600. FIG. 8 is a right side view of the protective cover 600. In the illustrated embodiment, the pressure tube portion 630 is sized to circumferentially surround the pressure tube 430 by slightly less than 180 degrees. In some embodiments, the pressure tube portion 630 can be sized to circumferentially surround the pressure tube 430 by 180 degrees. In some embodiments, the pressure tube portion 630 can be sized to circumferentially surround the pressure tube 430 by more than 180 degrees.

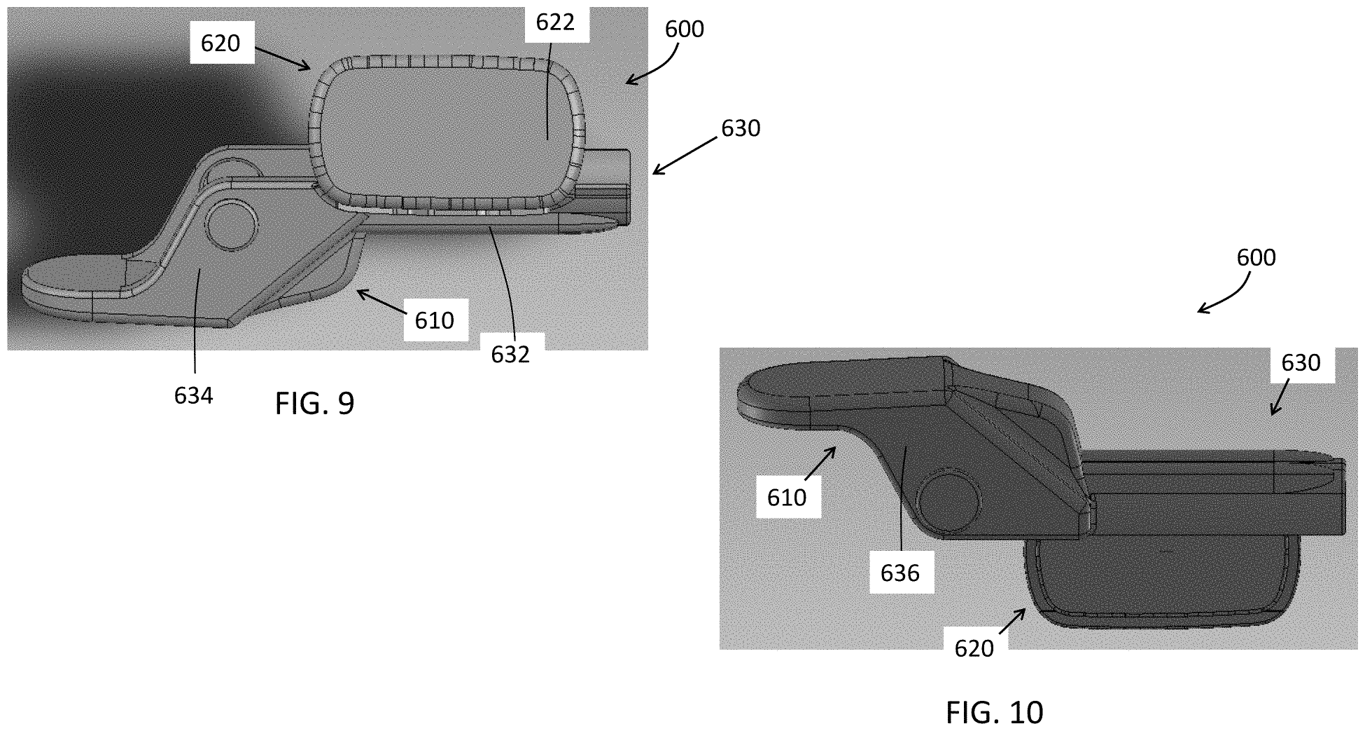

FIG. 9 is a top view of the protective cover 600. FIG. 10 is a bottom view of the protective cover 600.

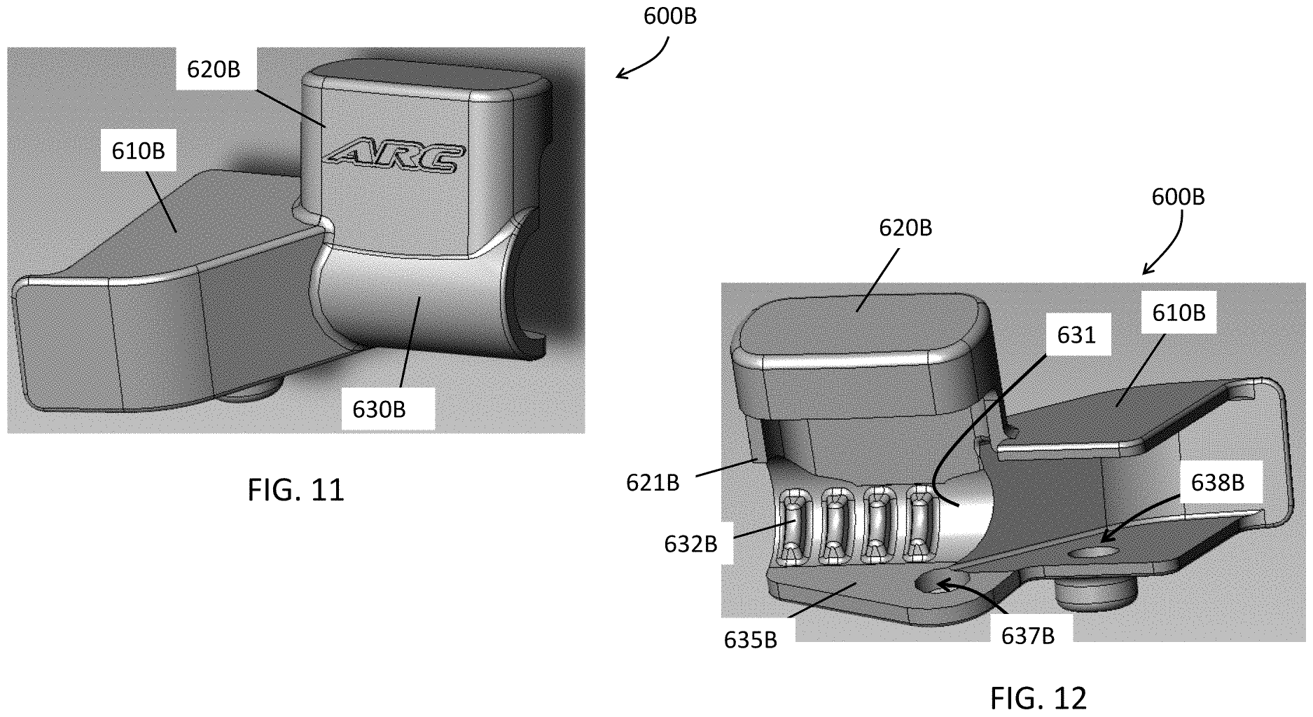

FIGS. 11-16 show various views of a protective cover 600B. The protective cover 600B can be similar to the protective cover 600 except as differently described. FIG. 11 shows a front view of the protective cover 600B. In the illustrated embodiment, the outer surface of the pressure tube portion 630B is devoid of ribs 632B. In some variants, the protective cover 600B can include ribs 632B disposed on the outer surface of the pressure tube portion 630B.

FIG. 12 is a rear view of the protective cover 600B. As shown, the pressure tube portion 630B can include a plurality of ribs 632B that are disposed on the inner surface 631B of the pressure tube portion 630B. In the illustrated embodiment, there are four substantially identical ribs 632B that are substantially equally spaced apart from one another and aligned along the circumferential direction of the pressure tube portion 630B. In some variants, the ribs 632B can be arranged to run along the inner surface 631 of the pressure tube portion 630B in the longitudinal direction. The protective cover 600B can include one, two, three, four, five, six, or more than six ribs 632B. The ribs 632B can be differently shaped from one another. For example, the plurality of ribs 632B can include circumferentially-oriented ribs that extend further along the circumferential direction and/or the longitudinal direction compared to a neighboring rib 632B. In some variants, the pressure tube portion 630B can include ribs 632B on both the inner and outer surfaces of the pressure tube portion 630B. The ribs 632B can be arranged in numerous combinations (e.g., longitudinal-oriented ribs 632B on inner surface 631 and circumferentially-oriented ribs 632B on the outer surface). The variants of the protective cover 600 that can be achieved by differently combining the features disclosed herein are each within the scope of the present disclosure and have been omitted from explicit recitation for the sake of clarity.

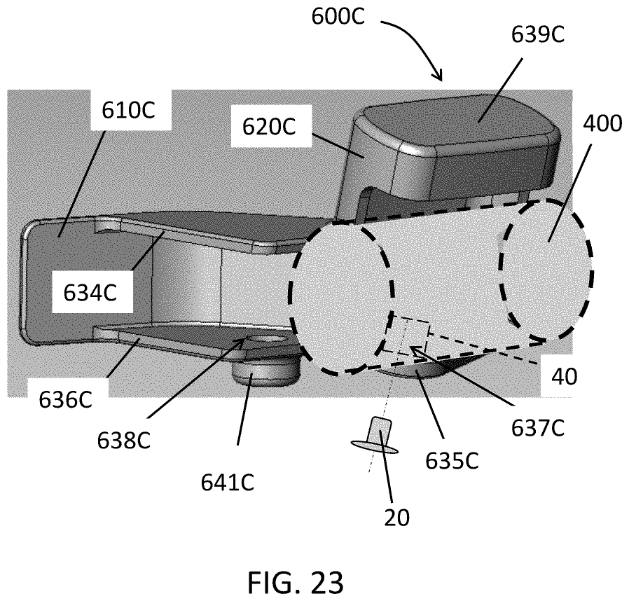

FIG. 12 shows the pressure tube portion 630B can include a flange 635B that extends rearward. The flange 635B can include a through hole 637B. The through hole 637B can be configured to help secure the protective cover 600B onto the brake or clutch assembly 100 that is covered by the protective cover 600B. The through hole 637B can be configured to align with a receiving port 40 (FIG. 23) disposed on a master cylinder assembly 400 to help secure the protective cover 600C to the brake or clutch assembly 100, as described herein. The pivot portion 610B can include one or more recesses 638B, as described herein. The recesses 638B can be configured to help secure the protective cover 600B onto the brake or clutch assembly 100 that is covered by the protective cover 600B, as discussed with regard to the protective cover 600 shown in FIG. 6.

The protective cover 600 can be arranged to wrap around and enclose the brake assembly 100 inserted therein. As shown in FIG. 12, the reservoir portion 620B can include a base portion 621B that can be curved to wrap around the reservoir-side face of the master cylinder assembly 400. The curved cylindrical form of the inside surface 631 of the pressure tube portion 630B can splay apart to allow the master cylinder assembly 400 to enter the confines of the pressure tube portion 630B. The pressure tube portion 630B can recoil to recover the curved cylindrical form once the master cylinder assembly 400 is seated within the pressure tube portion 630B, thereby securing the protective cover on the brake assembly.

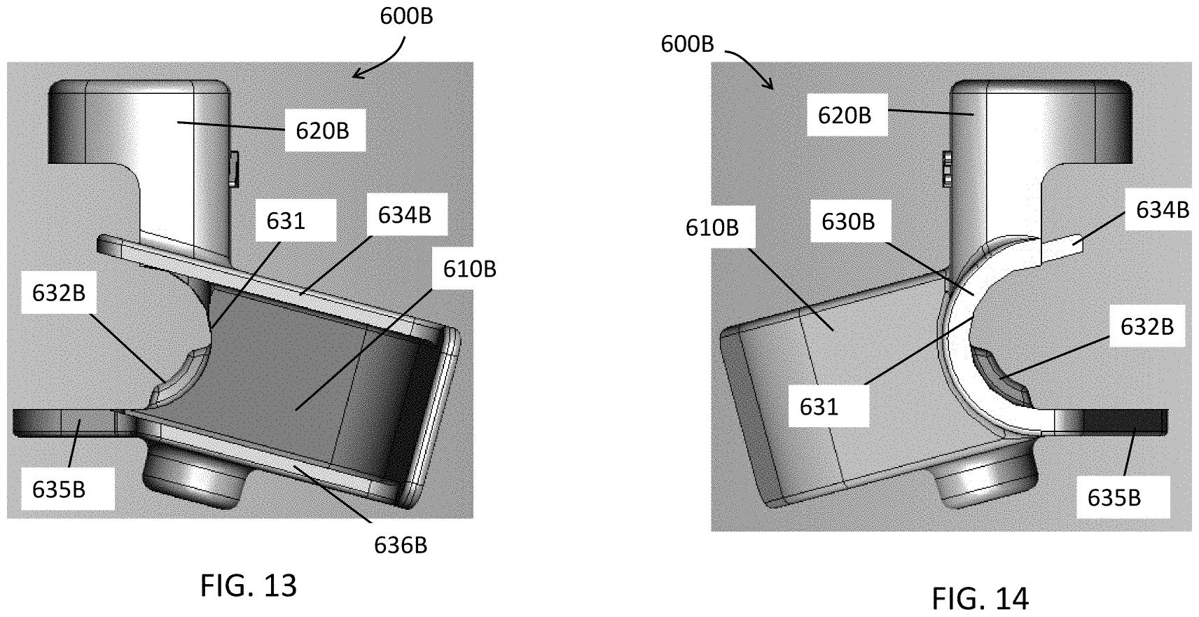

FIG. 13 is a left side view of the protective cover 600B. FIG. 14 is a right side view of the protective cover 600B. FIGS. 13 and 14 illustrate that the ribs 632B can extend into a portion of space that is occupied by the master cylinder assembly 400 (FIG. 1) of a clutch or brake assembly 100 when the protective cover 600B is seated onto the clutch or brake assembly 100. As discussed herein, the ribs 632B can be made of a resilient material, allowing the ribs 632B to compress against the master cylinder assembly 400 when the protective cover 600B is seated on the brake assembly 100. In some aspects, the compression of the ribs 632B can help maintain a snug fit of the protective cover 600B on the brake assembly 100.

In the illustrated embodiment, the pivot portion 610B includes a top pivot mount surface 634B and a bottom pivot mount surface 636B that are substantially similarly shaped and run substantially parallel with one another. As shown in FIG. 13, the top pivot mount surface 634B can extend over the flange 635B when viewed along a longitudinal axis of the pressure tube portion 630B. FIG. 12 shows that this protruding portion of the top pivot mount surface 634B can be longitudinally offset from the flange 635B along the longitudinal axis of the pressure tube portion 630B. As can be appreciated from FIGS. 12 and 13, the top pivot mount surface 634B and the flange 635B can splay apart from one another to receive the brake assembly 100 within the protective cover 600B and then recoil once the brake assembly 100 is seated within the protective cover 600B, thereby forming a resilient spring mechanism that help maintain a snug fit between the protective brake cover 600B and the brake assembly 100.

Turning again to FIG. 13, the flange 635B can be substantially parallel with the top surface of the reservoir portion 620B. The bottom pivot mount surface 636B can be angled away from the top surface of the reservoir portion 620B as the bottom pivot mount surface 636B extends away from the flange 635B, as shown. In the illustrated embodiment, the bottom pivot mount surface 636B is angled approximately 30 degrees below the horizon of the flange 635B. In some variants, the bottom pivot mount surface 636B can be angled below the flange 635B by and angle of about: 10 degrees, 20 degrees, 30 degrees, 40 degrees, 60 degrees, values between the aforementioned values, and otherwise. In some variants, the bottom pivot mount surface 636B can be angled below the flange 635B by and angle that is within the range of between about: 25 degrees to 35 degrees; 20 degrees to 40 degrees; 10 degrees to 60 degrees.

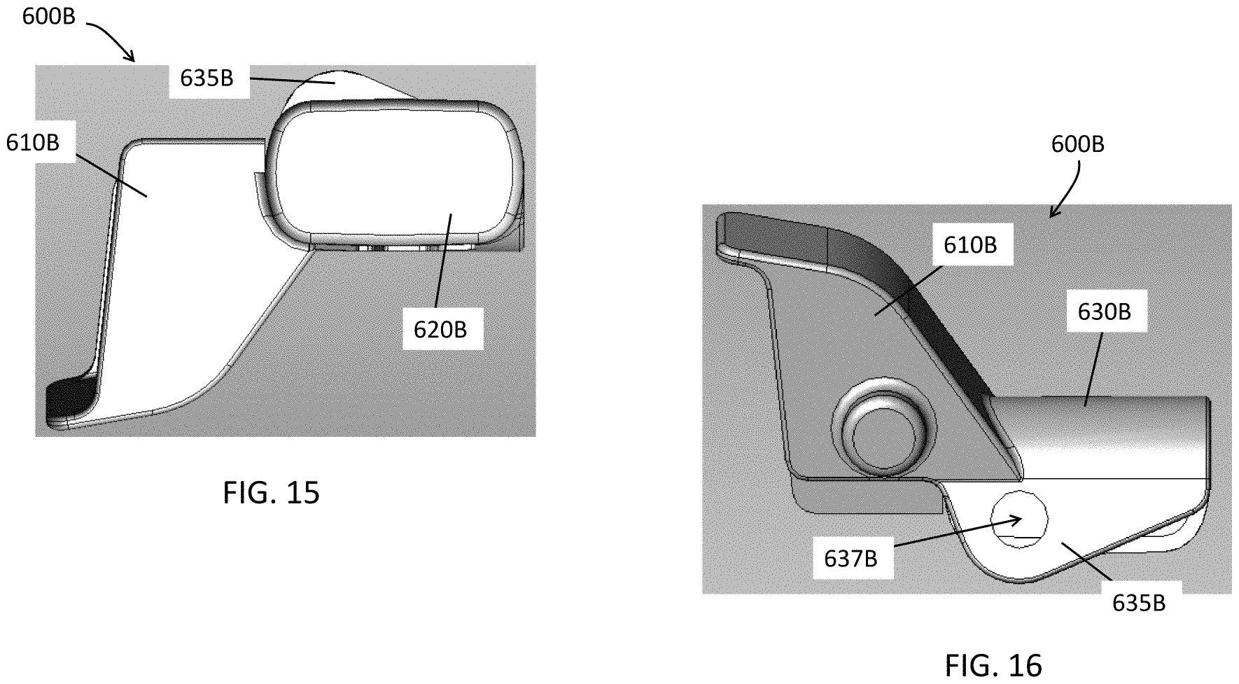

FIG. 15 is a top view of the protective cover 600B. FIG. 16 is a bottom view of the protective cover 600B. As shown, at least a portion of the flange 635B can extend rearward beyond the reservoir portion 620B.

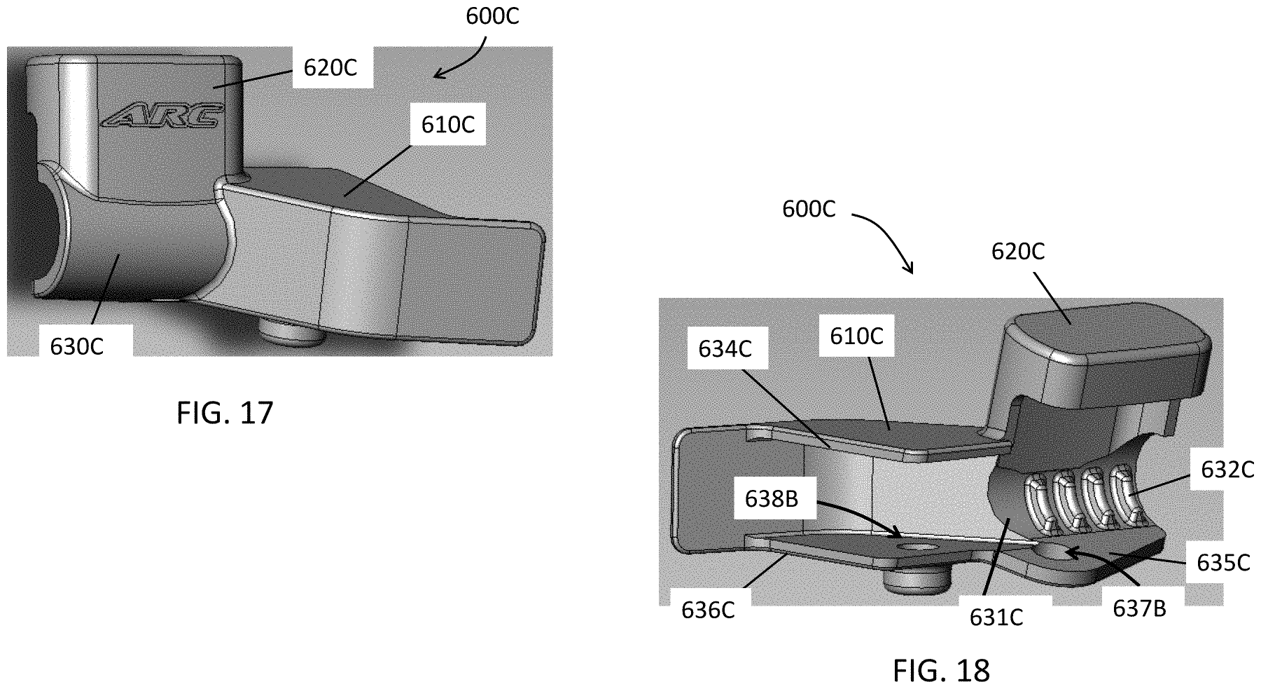

FIGS. 17-22 show various views of a protective cover 600C. The protective cover 600C can be similar to the protective cover 600B except as differently described. FIG. 17 shows a front view of the protective cover 600C. In the illustrated embodiment, the pivot portion 610C extends from the right side portion of the pressure tube portion 630C. In this way, the protective cover 600C can be arranged to cover a clutch assembly, while the protective covers 600, 600B can have the pivot portion 610, 610B extending from the left side portion of the pressure tube portion 630, 630B such that the protective covers 600, 600B can be adapted to fit onto a brake assembly 100 (FIG. 3). In the illustrated embodiment, the outer surface of the pressure tube portion 630C is devoid of ribs 632C and the inner surface includes a plurality of circumferentially-oriented ribs 632C. In some variants, the protective cover 600C can include ribs 632C disposed on the outer surface of the pressure tube portion 630C, as discussed herein. As described previously, the ribs 632C and other disclosed features of the protective covers 600, 600B, 600C can be combined differently with one another to form additional variants of the protective cover 600 that are omitted from explicit recitation for the sake of clarity.

FIG. 18 is a rear view of the protective cover 600C. As shown, the pressure tube portion 630C can include a plurality of ribs 632C that are disposed on the inner surface 631C of the pressure tube portion 630B. In the illustrated embodiment, there are four substantially identical ribs 632B that are substantially equally spaced apart from one another and aligned along the circumferential direction of the pressure tube portion 630C. In some variants, the ribs 632C can be arranged to run along the inner surface of the pressure tube portion 630C in the longitudinal direction. The protective cover 600C can include one, two, three, four, five, six, or more than six ribs 632C. The ribs 632C can be differently shaped from one another, as described previously with regard to the protective cover 600B. In some variants, the pressure tube portion 630C can include ribs 632C on both the inner and outer surfaces of the pressure tube portion 630C. The ribs 632C can be arranged in numerous combinations (e.g., longitudinal-oriented ribs 632C on inner surface and circumferentially-oriented ribs 632C on the outer surface). These numerous variants of the protective cover 600C can be achieved by differently combining the features disclosed herein and are within the scope of the present disclosure but have been omitted from explicit recitation for the sake of clarity.

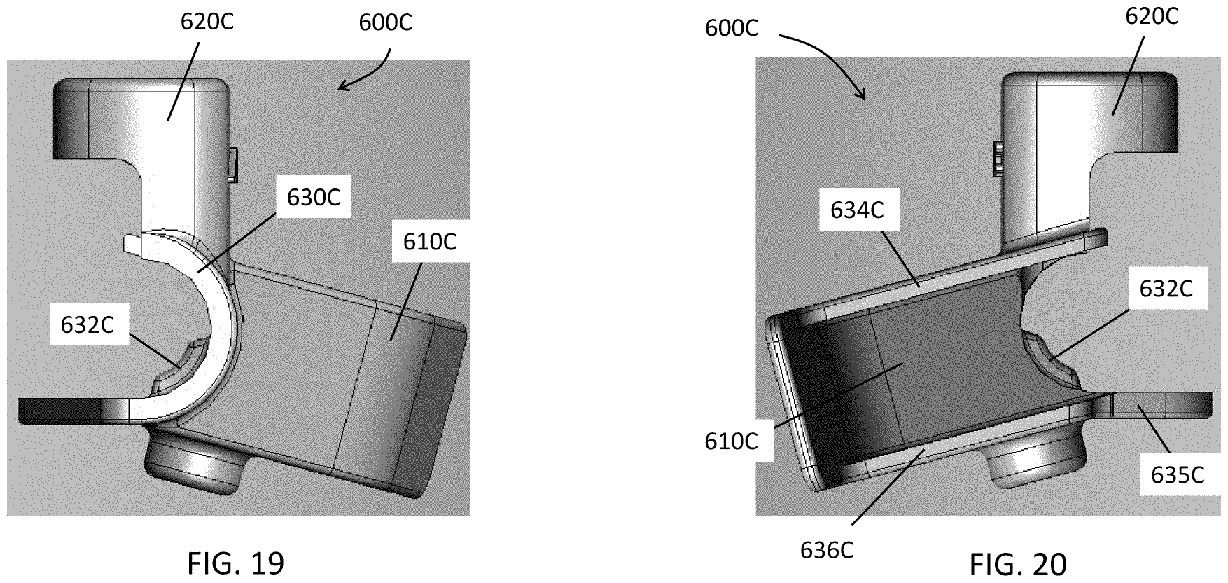

FIG. 19 is a left side view of the protective cover 600C. FIG. 20 is a right side view of the protective cover 600C. As discussed with regard to protective cover 600B, the ribs 632C can extend into a portion of space that is occupied by a master cylinder assembly 400 (FIG. 1) of a clutch or brake assembly 100 when the protective cover 600C is seated onto the clutch or brake assembly 100. In some aspects, the ribs 632C can compress and help maintain a snug fit of the protective cover 600C on a clutch assembly. In the illustrated embodiment, the pivot portion 610C includes a top pivot mount surface 634C and a bottom pivot mount surface 636C that are substantially similarly shaped and run substantially parallel with one another. As discussed, the bottom pivot mount surface 636C can be angled below the horizon of the flange 635C by and angle of about: 10 degrees, 20 degrees, 30 degrees, 40 degrees, 60 degrees, values between the aforementioned values, and otherwise. In some variants, the bottom pivot mount surface 636C can be angled below the flange 635C by and angle that is within the range of between about: 25 degrees to 35 degrees; 20 degrees to 40 degrees; or 10 degrees to 60 degrees.

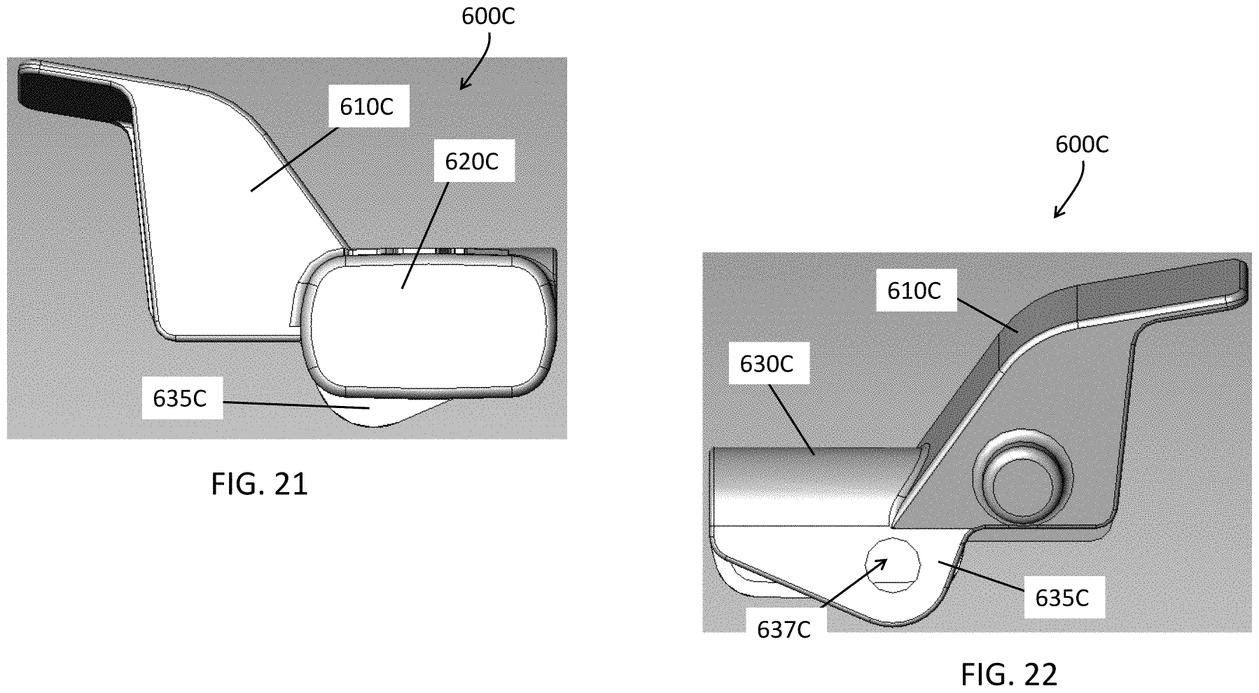

FIG. 21 is a top view of the protective cover 600C. FIG. 22 is a bottom view of the protective cover 600C. As shown, at least a portion of the flange 635C can extend rearward beyond the reservoir portion 620C. The flange 635C can include a through hole 637C, and the pivot portion 610C can include a recess 638C (FIG. 18), as described previously with regard to the protective cover 600B shown in FIGS. 11-16.

FIG. 23 shows in phantom a portion of a master cylinder assembly 400 seated within the protective cover 600C. As discussed, the protective cover 600C can have a through hole 637C disposed on a flange 635C that extends rearward from the pressure tube portion 630C. The through hole 637C can be configured to align with a receiving port 40 disposed on the master cylinder assembly 400. A fastener 20 can pass through the through hole 637C to anchor in the receiving port 40. In some aspects, the fastener 20 can be a threaded screw that matches an internal thread of the receiving port 40. Other modes of fastening can be used (e.g., spring clip, interference fit).

As shown in FIG. 23, the flange 635C can be adapted to form part of a resilient spring system that helps maintain a snug fit between the protective cover 600C and the brake assembly 100. As described, the protective cover 600C can be made of resilient material and can splay apart to allow the brake assembly 100 to be inserted into the protective cover 600C. The portions of the brake assembly 100 that fit within the pivot portion 610C and the reservoir portion 620 are omitted from the drawing for the sake of clarity. The flange 635C and the bottom pivot mount surface 636C can splay away from a cap portion 639C of the reservoir portion 620C and the top pivot mount surface 634C of the pivot portion 610C. In the illustrated embodiment, the bottom pivot mount surface 636C includes a recess 638C and a protrusion 641C that can be adapted to interlock with corresponding features disposed on the brake assembly 100 or other structure, as described herein.

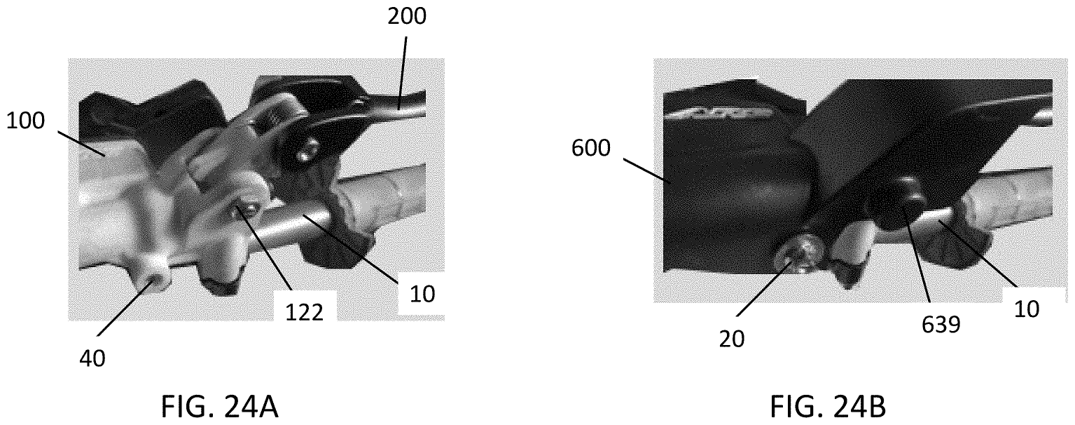

FIG. 24A depicts a bottom view of a brake assembly 100 mounted on a handlebar 10 of a dirt bike. FIG. 24B shows a bottom view of a protective cover 600 secured to the brake assembly 100 shown in FIG. 24A. As discussed, a fastener 20 can pass through the through hole 237 (FIG. 23) of the protective cover 600 to anchor the protective cover 600 onto the brake assembly 100. The fastener 20 can be sized to anchor within the receiving port 40 disposed on the brake assembly 100. As discussed, the protective cover 600 can include a recess 638 (FIG. 23) defined within the protrusion 639 and sized to receive a pivot fastener 122 of the brake assembly 100.

### CONCLUSION

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

What is claimed is:

1. A protective cover for a hydraulic brake or clutch assembly, the protective cover comprising:
a pressure tube portion sized to fit over at least a portion of a master cylinder of the hydraulic brake or clutch assembly, the pressure tube portion extending along a first longitudinal direction;
a reservoir portion sized to fit over at least a portion of a reservoir of the hydraulic brake or clutch assembly, the reservoir portion extending away from the pressure tube portion along a second longitudinal direction; and
a pivot portion extending away from the pressure tube portion along the first longitudinal direction.

2. The protective cover of claim 1 further comprising a plurality of ribs disposed on the pressure tube portion.

3. The protective cover of claim 2, wherein at least one of the plurality of ribs is disposed on an inner surface of the pressure tube portion.

4. The protective cover of claim 2, wherein at least one of the plurality or ribs is disposed on an outer surface of the pressure tube portion.

5. The protective cover of claim 2, wherein at least one of the plurality of ribs extends along the first longitudinal direction.

6. The protective cover of claim 2, wherein at least one of the plurality of ribs extends along a circumferential direction of the pressure tube portion.

7. The protective cover of claim 1, wherein the first and second longitudinal directions are orthogonal to one another.

8. The protective cover of claim 1, wherein at least two of the pressure tube portion, the reservoir portion, and the pivot portion form a unitary structure with one another.

9. The protective cover of claim 8, wherein the pressure tube portion, the reservoir portion, and the pivot portion form the unitary structure.

10. The protective cover of claim 1, wherein the pivot portion is disposed adjacent to a left side portion of the pressure tube portion as viewed from a front of the protective cover.

11. The protective cover of claim 1, wherein the pivot portion is disposed adjacent to a right side portion of the pressure tube portion as viewed from a front of the protective cover.

12. The protective cover of claim 1, wherein the protective cover further comprises a flange extending along the pressure tube portion in the first longitudinal direction, the flange extending away from the pressure tube portion along a third longitudinal direction that is orthogonal to each of the first and second longitudinal directions.

13. The protective cover of claim 12, wherein the flange comprises a through hole.

14. The protective cover of claim 13, wherein the through hole is configured to align with a receiving port disposed on a master cylinder of the hydraulic brake or clutch assembly.

15. The protective cover of claim 14, wherein the through hole is sized to allow a fastener to pass through the through hole and anchor with the receiving port.

16. The protective cover of claim 12, wherein the pivot portion comprises a bottom pivot mount surface that extends away from the flange, the bottom pivot mounting surface extending away from the flange along a direction that is angled away from the reservoir portion by an angle between 10 degrees and 60 degrees.

17. The protective cover of claim 12, wherein at least a portion of the flange extends rearward beyond the reservoir portion.

18. The protective cover of claim 1, wherein the protective cover is made of plastic or rubber.

19. The protective cover of claim 1, wherein the protective cover is sufficiently resilient to allow the protective cover to snap fit onto the clutch or brake assembly.

20. The protective cover of claim 1, wherein a cross-sectional shape of the pressure tube portion as viewed in a plane transverse to the first direction has a crescent shape.
